(19) United States
(12) Patent Application Publication
(10) Pub. No.: US 2014/0082585 A1
(43) Pub. Date: Mar. 20, 2014

(54) METHOD OF CREATING A SOFTWARE APPLICATION, THE METHOD BEING PERFORMED BY AN ENGINE

(71) Applicant: Heavenize, Paris (FR)

(72) Inventor: Jose Chillan, Paris (FR)

(21) Appl. No.: 13/953,976

(22) Filed: Jul. 30, 2013

(30) Foreign Application Priority Data
Jul. 31, 2012 (FR) 1257454

(51) Int. Cl. G06F 9/44

(52) U.S. Cl. CPC G06F 8/20
USPC 717/104

(57) ABSTRACT

This disclosure includes a method performed by a generic engine for dynamically creating a software application suitable for satisfying an initial objective. The engine may interrogate a knowledge base including a computer object including an interpretable module together with a description of a result obtained on interpreting said module. Various implementations include sending a request to the knowledge base that includes a “current” objective; obtaining results, which may be partial, by interpreting a module of a computer object received in response to the request; compiling the obtained partial results to determine whether they enable a “final” result to be formed that satisfies the initial objective; if so, sending the final result in response to the initial objective; if not, defining a new current objective from at least one of said results, said complied partial result and possibly current objectives defined during preceding iterations, and executing another iteration.

### BACKGROUND OF THE INVENTION

The present invention lies in the field of creating software applications.

In general, a software application publisher seeks to propose software applications suitable for satisfying customers who have a variety of requirements or constraints.

Consequently, whenever possible, on developing a new application the publisher seeks to rely on applications that have already been developed.

Correspondingly, the businesses that use software applications may seek to have applications that are made-to-measure, i.e. that satisfy the needs of its various sectors of activity as closely as possible.

There thus exists a need to simplify the creation of software applications firstly to enable the publisher to get a return on its developments, while also enabling user businesses to personalize their applications to satisfy their own needs.

In general, the users of software applications have difficulty in understanding where the complexity lies in the computer tools they use, and this leads to a very high degree of discrepancy between a user's perception of the cost of satisfying their requests and the real cost of implementation in a software application. This gap is due to the fact that software needs to convert human requirements into a computer object that can be executed by a processor. Unfortunately, the human brain and processors operate on completely different bases and they split up problems completely differently. A software application requires interconnections between programming elements that are defined by a programmer, and that might need to be revised completely by some small change inspecifications. The programmer is an expert in translating from the human mode of thinking to the mode needed for executing a program by a processor.

Numerous technologies have been created for reducing the cost of implementing and upgrading software, in particular by relying on making source code reusable or modular. Patent DE 1 020 08060440A1 in the name of Siemens advances on these lines by proposing to seek out and adapt existing source code automatically as a function of needs that may be functional or technical. In the same context, the use of object-oriented technologies has made it possible to postpone implementing certain functions of applications and thereby increase the flexibility of applications.

Nevertheless, the fundamental problem remains: developing applications will continue to be complex so long as software programming is based on bases that are incomprehensible for users and different from the ways in which humans think.

It is therefore advantageous to be able to find means for approaching the mode of thinking required for developing a software application to the human mode of thinking, in order to be able to adapt and evolve the application with an impact that is easily measurable for users and an ability to explain the details of the processing to people who are not experts.

The present invention differs from conventional approaches in that it makes it possible, dynamically, to produce new applications suitable for satisfying new requirements without it being necessary to produce source code, by dynamically re-arranging and adapting pre-existing elements of source code and the way in which they are sequenced, with these functions being delegated to a generic engine that takes charge of this complex portion of programming.

### SUMMARY AND OBJECT OF THE INVENTION

To this end, the invention provides a method performed by a generic engine for dynamically creating a software application suitabie for satisfying an initial objective received by the engine, the engine being suitable for interrogating a knowledge base including at least one computer object, each object including at least one module interpretable by the engine together with a description of a result obtained by the engine on interpreting the module.

The method comprises at least one iteration, each iteration comprising:
sending a request to the knowledge base, the request being constructed from a “current” objective, in order to obtain at least one computer object such that interpreting a module of the object by the engine aims to obtain at least a “partial” result suitable for satisfying the current objective, at least in part;
obtaining at least one result by interpreting at least one module of a computer object received during the iteration;
obtaining a compiled partial result by compiling at least one of the partial results obtained during the iterations in order to determine whether they enable a “final” result to be formed that satisfies the initial objective;
if so, sending the final result in response to the initial objective; and
if not, defining at least one new current objective defined from at least one of the results or from the complied partial result and possibly current objectives defined during preceding iterations, and executing the following iteration;
the current objective included in the request sent during the first iteration is constituted by the initial objective, and the software application corresponds to the operations performed by the engine in order to satisfy the initial objective.

The above-mentioned interpretation may consist in executing the code, if any, that is associated with the computer object.

The compilation that generates the partial result from at least one of the previously obtained partial result is not compilation in the computer meaning of the term but in the conventional meaning of aggregating these results and putting them together.

Correspondingly, the invention also provides a generic engine suitable for dynamically creating a software application suitable for satisfying an initial objective received by the engine, the engine being suitable for communicating with a knowledge base including at least one computer object, each computer object including at least module interpretable by the engine together with a description of a result obtained by the engine on interpreting the module.

The engine includes control means suitable for acting during at least one iteration to make use of:
means for sending a request to the knowledge base, the request being constructed from a “current” objective, in order to obtain at least one computer object such that interpreting a module of the object by the engine aims to obtain at least one “partial” result suitable for satisfying the current objective, at least in part;
means for obtaining at least one result by interpreting at least one module of a computer object received from the knowledge base during the iteration;
means for obtaining a compiled partial result by compiling at least one of the results obtained during the iterations in order to determine whether they enable a “final” result to be formed that satisfies the initial objective; and
means for sending the final result in response to the initial objective, which means are triggered by the control means when the compiled partial result constitutes a final result and satisfies the initial objective;
the control means being configured, when the compiled partial result does not constitute the final result to:
trigger means for defining at least one new current objective defined from at least one of the results or from the compiled partial result and possibly from current objectives defined during preceding iterations; and
executing a new iteration;

the current objective included in the request sent during the first iteration being constituted by the initial objective, the software application corresponding to the operations performed by the engine in order to_ satisfy the initial objective.

The invention also relates to a system for creating a software application, the system comprising a generic engine as specified above together with a knowledge base.

Thus, and in general, the invention proposes a generic engine suitable for dynamically and automatically creating a software application suitable for satisfying an initial objective, i.e. a particular need, that is defined, i.e. personalized, for a user business.

Because it is generic, the engine can be used regardless of the field of the software application; this makes it possible to the developer of the engine to capitalize on this development for numerous clients.

The generic engine collaborates with a knowledge base of content and grammar that may be defined for a particular context. For example, a business using the invention may design a knowledge base specific to that business and within that base it may define computer objects that correspond to different sectors of activity of the business.

The initial objective may be sent by a program that optionally contains the engine.

In general, the definition of a current objective by the engine consists in creating an intermediate question that is sent to the knowledge base in order to be solved at least in part, for the purpose of ending up by satisfying the initial objective.

In response to the intermediate question, the engine obtains a result that may be constituted either by a new intermediate question, or by a partial result.

Partial results are responses or elements of responses to intermediate questions obtained by interpretation of an object module coming from the knowledge base.

Interpretation may also cause a command to be sent to a third-party component, which in turn returns a response to the engine (either a partial result, or a final result, or a new question).

The third-party component may contain information that is updated over time.

The invention covers the situation in which a given object is processed several times, i.e. its module(s) is/are interpreted several times over.

Compiling partial results is equivalent to combining partial results obtained during iterations for the purpose of responding to the initial objective or at least in part to an intermediate question.

The compilation step may be performed either:
after interpreting a plurality of modules; or else
after interpreting each module.

In a particular implementation of the invention, the method comprises:
a step of creating an identifier specific to the initial objective on receiving the initial objective;
a step of storing the identifier in a static data structure, the current objectives and their partial results being stored in association with the identifier;
a step of interrogating the static data structure to determine whether the current objective is stored in the static data structure in association with a valid partial result; and if so:
replacing the steps of sending the request to the knowledge base, of receiving a list of objects selected by the knowledge base, and of obtaining at least one result, by a step of reading the static data structure to obtain the partial result.

In a variant, it is also possible to store the other results, i.e. the compiled partial results and the final results.

In general, a first advantage of this static data structure is to retain the history of certain processes that have been performed by the engine in order to be able to replace the sequencing of the operations that have been performed in order to obtain the final result.

A second advantage of this static data structure is to enable the engine subsequently to consult the static data structure in order to avoid reproducing operations (interrogation the knowledge base, interpreting a module, . . .) when the results of those operations are saved in the static data structure.

The static data structure makes it possible to optimize the calculations of the engine by avoiding certain repetitions, the step of reading the static data structure making it possible to save time concerning iterations that have already been performed in order to obtain the looked-for partial result.

In this implementation, the static data structure also makes it possible to re-use a result obtained by the method in order to respond to a first initial objective when subsequently executing the method in order to respond to some other initial objective.

In a particular implementation of the invention, the method may include a step of generating source code from the computer objects contained in the knowledge base in order to optimize execution time.

In another implementation, the method may launch the interpretation of a first computer object that corresponds to one possible execution branch, and may possibly backtrack in order to launch a second computer object if the first does not satisfy certain criteria of the objective, which criteria may be technical or functional, such as processing time, memory usage, or the accuracy of the result.

In another implementation, the method may launch the interpretation of a plurality of computer objects in parallel and may select the partial result that is the most pertinent with respect to criteria defined in the objective.

In another implementation, the method includes a step of reinitializing the static data structure in order to prevent such re-utilization of results.

In a particular implementation of the invention, the partial result is valid if it is stored in the static data structure with a non-expired lifetime.

The partial result need not be permanent, and might therefore falsify the accuracy of the final result. Having a lifetime associated in the static data structure with the partial result makes it possible to handle this problem.

In a particular implementation of the invention, the knowledge base has an information hierarchy and returns objects to the engine only when the description of those objects contains information of order in the hierarchy that is compatible with the request.

The hierarchy makes it possible to define a vocabulary going from very general to very narrow, the vocabulary being for use in formulating initial objectives.

In this implementation, if the initial objective uses narrow vocabulary, only objects having descriptions that include this narrow vocabulary will be returned. In contrast, if the initial objective uses general vocabulary, then all of the objects having descriptions that include general vocabulary or vocabulary that is narrower will be returned.

The knowledge base may return objects to the engine that are ordered as a function of the order of the information contained in the descriptions of those objects and in the request.

In the particular implementation in which the objects received in response to a request include an order number, the module that is interpreted during the iteration is determined as a function of the order number of the object to which it relates.

The object in the list that is to be processed by the engine may also be selected in random manner.

The invention also provides a computer program including instructions for executing the above-mentioned method when the program is executed by a computer.

The computer program may be dynamically linked with the engine or may be statically linked with the engine.

The invention also relates to a computer readable storage medium haying a computer program stored thereon including instructions for executing steps of the above-specified method.

In a particular implementation of the invention, the initial objective is accompanied by data for authenticating the user originating the initial objective or by data for authenticating an application originating the initial objective, and the knowledge base returns objects to the engine that are selected as a function of the authentication data.

The authentication data may give access to the static data structure as written while processing a preceding initial objective.

### BRIEF DESCRIPTION OF THE FIGURES

Other characteristics and advantages of the present invention appear from the following description made with reference to the accompanying figures which show implementations having no limiting character. In the figures:

FIG. 1 is a flow chart showing the main steps of a method of creating a software application in a first implementation of the invention;

FIG. 2 is a diagram showing an example of a system of the invention for creating a software application; and

FIG. 3 is a flow chart showing the main steps of a method of creating a software application in a second implementation of the invention.

### DETAILED DESCRIPTION

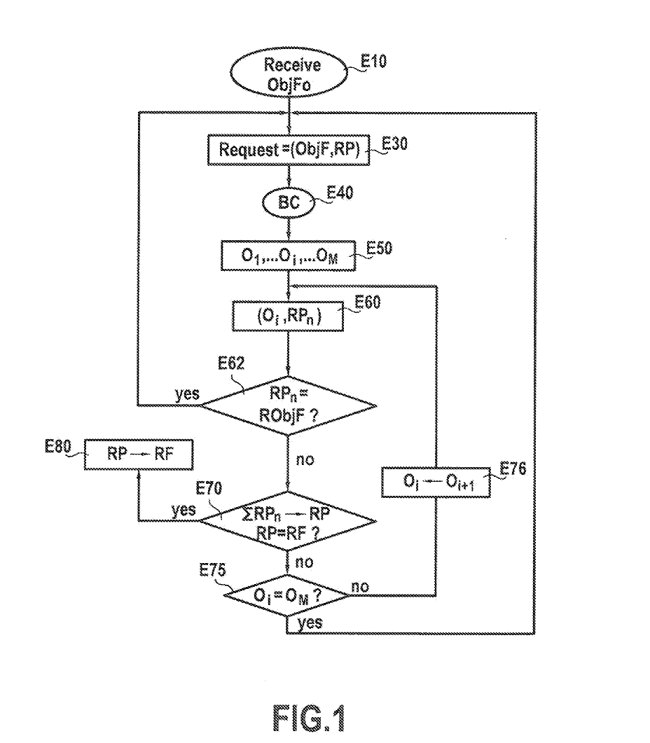

FIG. 1 is a flow chart showing the main steps of a method of creating a software application in accordance with a first implementation of the invention. In general, the method consists in creating a software application to satisfy an initial objective ObjF₀ received by the engine.

This initial objective ObjF₀ may contain information referred to as a “sector of activity” information. This information determines the choice of objects returned by the knowledge base.

In general, the method of the invention relies on a generic engine that is independent of the sector of activity, and on a knowledge base that may contain objects that are specific to the sector of activity, in order to respond to the initial objective in appropriate manner. The method described below should be taken from the point of view of the generic engine.

The engine receives the initial objective ObjF₀ during a step E10. By way of example, this initial objective may be sent to the engine by a web application or by a spreadsheet.

Step E30 consists in formulating a request including a current objective (namely the initial objective on the first iteration) and in defining a variable written RP.

During a step E40, the request formulated in step E30 is sent to the knowledge base.

In general, the knowledge base includes a certain number of user objects, each object comprising a description that uses a given grammar to define the results that can be obtained by processing the object together with at least one module that is interpretable by the generic engine in order to obtain the result.

Thus, when the knowledge base 300 receives the request formulated by the generic engine in step E30 and sent in step E40, it is suitable for analyzing the descriptions of objects in order to determine whether the objects are suitable for satisfying the request, at least in part.

During a step E50, the generic engine thus receives a list of objects O₁, . . . , Oᵢ , . . . , O_{M} selected by the knowledge base as a function of their descriptions, in order to satisfy, at least in part, the current objective of the request sent in step E40.

In a preferred implementation, the objects received by generic engine in step E50 are ordered by the knowledge base 300. Under such circumstances, the generic engine begins by interpreting one or more modules of the first object.

In a step E60, interpreting the module of object Oᵢ serves to obtain a result that might satisfy the initial objective, at least in part.

This result, written RPₙ, may be:
the result making it possible to satisfy the initial objective, in which case the result is referred to as the “final” result and written RF;
a result that is said to be “partial”, enabling the initial objective to be satisfied in part, the final result RF potentially being obtained by compiling partial results Rₙ; or
at least one new objective RObjF, this objective serving as a current objective for a new iteration of the method as described below with reference to step E62.

By way of example, it should be observed that the final result RF or an above-mentioned partial result RPₙ may be obtained directly by interpreting the code of the computer object, with interpretation of the code of the object thus being capable of causing a command to be sent to a third-party component, e.g. a database or a web server.

The step E60 is followed by a test E62 during which it is verified whether the result RPₙ is a new objective RObjF. If it is, the method returns to the step E30 for a new iteration seeking to process this new objective. In the other two circumstances (partial result or final result), the test E62 is followed by a step E70 consisting in determining whether the result RPₙ obtained during the current iteration by interpreting a module of the first object received from the knowledge base 300 corresponds to the final result RF defined by the initial objective received by the engine.

If so, the method of the invention returns the final result RF during a step E80.

If not, it is appropriate to interpret the modules of other objects received in step E50, so long as any remain, as shown at E76 in FIG. 1.

For this purpose, the method includes a test E75 for verifying whether all of the objects received in step E50 have been processed.

When the result RPₙ obtained by interpreting the nodule of one of these objects (step E60) is a partial result, then it is determined in step E70 whether the partial results obtained during this iteration and the preceding iterations, if any, enable the Initial objective to be satisfied. This step E70 consists in compiling the partial results obtained during this iteration and the preceding iteration in order to obtain a result referred to as a “compiled” partial result, and in verifying whether this compiled partial result corresponds to the final result RF satisfying the initial objective. If so the compiled partial result is sent to step E80.

If all of the computer objects received in step E50 have been processed without it being possible to obtain the final result RF expected in step E70, an attempt is made at defining a new current objective:
if this is not possible, the processing by the engine stops;
if this is possible, a new iteration is executed by returning to step E30, the new current objective being either a partial result obtained during the current iteration, or else a current objective defined from the compiled partial result.

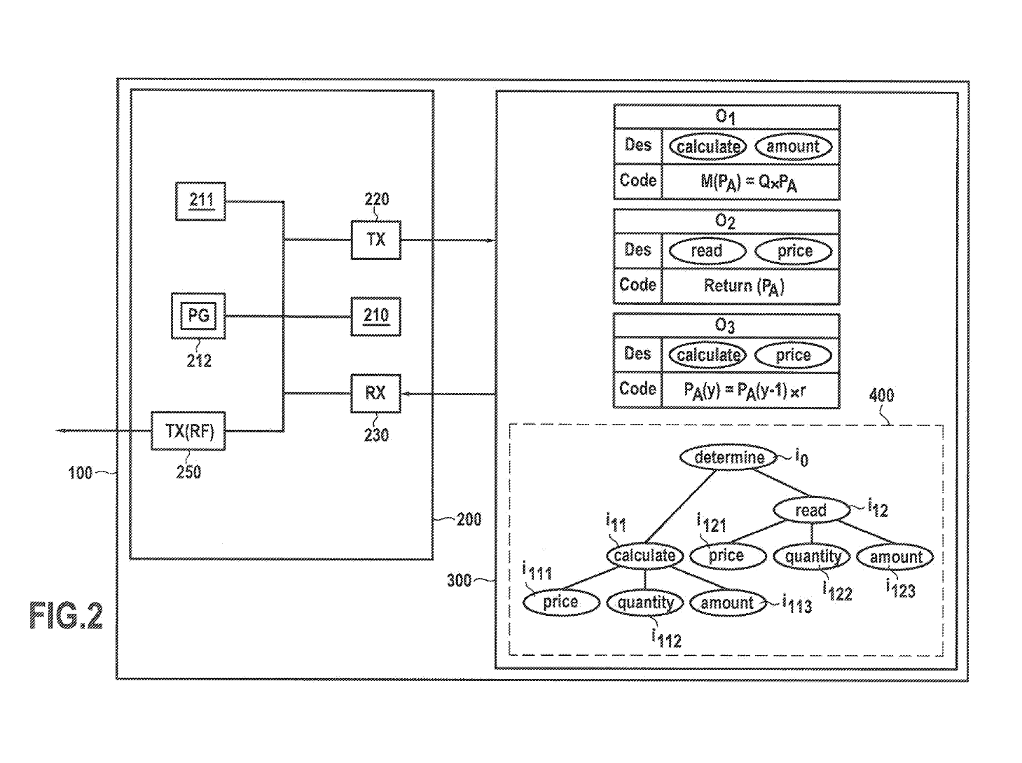

FIG. 2 shows a system 100 in accordance with the invention including a generic engine 200 and a knowledge base 300.

In the presently-described embodiment, the generic engine 200 has the hardware architecture of a computer. In particular, it comprises a processor 210, random access memory (RAM) 211, and a read only memory (ROM) 212. This ROM 212 constitutes a medium of the invention and it stores a computer program PG of the invention that, when executed, performs the steps of the flow chart described above with reference to FIG. 1.

In co-operation with the program PG and the RAM 211, the processor 210 constitutes specifically means for controlling the iterations of the method and means for acting during each of these iterations to:
control the means 220 for sending requests to the knowledge base 300;
interpret modules of the computer objects received from the knowledge base 300 by receiver means 230, in order to obtain results RPn, RObjF;
obtain compiled partial results RP by compiling results RPn obtained during the various iterations;
determine whether these compiled partial results make it possible to form a final result RF corresponding to the initial objective;
trigger the sending of the final result by means 250 in response to the initial objective when the compiled partial result RP constitutes a final result RF and satisfies the initial objective; and
define one or more new current objectives from the results RObjF or from said compiled partial result RP, and possibly from current objectives ObjF defined during earlier Iterations.

The RAM 211 stores the variables needed for executing the program PG. In particular, the RAM 211 stores the results RPₙ (including the new objectives RObjF) and RP, the current objectives ObjF defined during the various iterations of the method, together with the computer objects Oᵢ received during those iterations.

In this example, the generic engine 200 dynamically creates a software application and responds to an initial objective, e.g. as received from a spreadsheet.

In particular, in the presently-described example, the initial objective is to calculate the amount M of an invoice F, the invoice F including the reference of an article A and a quantity Q of that article. Thus, the request as formulated and stored in the RAM 211 in step E30 by the processor 210 contains two tags, namely: a first tag “calculate” and a second tag “amount”.

In this example, the knowledge base 300 has three objects O₁, O₂, and O₃, and an information hierarchy in the form of a tree.

The first object O₁ includes a description DES with two tags: “calculate” and “amount”.

The “calculate” first tag is information referenced I₁₁. The “amount” second tag is information referenced I₁₁₃.

The object O₁ also includes code for calculating an amount M(P_{A}) on the basis of a quantity Q and of the price P_{A} of an article A.

The object O₂ includes a description DES having two tags, namely a first tag “read” and a second tag “price”.

This object O₂ also has code with instructions suitable for returning the price P_{A} of an article A as read from a database.

A third object O₃ includes a description DES with a “calculate” tag and a “price” tag.

The object O₃ also includes code enabling a price P_{A} of an article A in a year y to be calculated as a function of the price of the article during the preceding year (y-1) and of an inflation rate r.

In this example, the knowledge base includes a hierarchy 400 in the form of a tree.

This tree has a first level i₀ with a root including the “determine” tag.

This root has two children, respectively the “calculate” tag (information i₁₁) and the “read” tag (information i₁₂).

Each of these children i₁₁ and i₁₂ in this example has three respective children at level 2, namely:

for the “calculate” node i₁₁: the children “price” (i₁₁₁), “quantity” (i₁₁₂), and “amount” (i₁₁₃); and
for the “read” node: the child “price” (i₁₂₁), the child “quantity” (i₁₂₂), and the child “amount” (ᵢ₁₂₃).

When the knowledge base receives the request sent to step E40, the knowledge base 300 searches for objects in which the description includes the tag “calculate”, and among those objects, it searches for objects in which the description includes the tag “amount”.

In the presently-described example, only the object O₁ satisfies these criteria.

Consequently, during a step E50, the knowledge base returns the single object O₁, which object is received by the receiver means 230 and stored in the RAM 211.

During a step E60, the processor 210 interprets the code of the object O₁, which in this example amounts to seeking to solve the equation contained in the code of object O₁.

The quantity Q of articles is known from the invoice F, however the price P_{A} of the article A is unknown. Consequently, the result RObjF of this interpretation leads, in this iteration, to formulating a new objective, namely determining the price P_{A}. This result, in other words this new objective, is stored in the RAM 211.

The step E60 is followed by a compilation step E70 that is implemented by the processor 210 with the help of the RAM 211 containing the various results obtained during the preceding iterations. During the first iteration, there is nothing to compile.

Compilation step E70 is followed by a step E75 during which the processor 210 verifies whether other objects received in the knowledge base 300 need to be processed. This is not necessary in this example since only the object O₁ has been sent.

Consequently, the processor causes the step E75 to be followed by a step E30 of formulating a new request from a current objective, which is determining the price P_{A}. During the step E30 of the new iteration, a request is formulated, and it includes the tags “determine” and “price”; a second variable RP is created.

This request is sent to the knowledge base 300 during a step E40 by the sender means 220.

After receiving this request, the knowledge base 300 uses the hierarchy 400 and the “determine” tag to identify two objects O₂ and O₃ that include respective descriptions with the “read” and “calculate” tags and that present orders in the hierarchy 400 lower than the order of the “determine” tag.

Naturally, these two objects O₂ and O₃ are eligible since their descriptions contain the “price” tag.

In this example, the order of the “read” tag in the hierarchy 400 is higher than the order of the “calculate” tag.

Consequently, the knowledge base sends the two objects O₂ and O₃ in that order to step E50, and the means 230 receive this ordered list of two objects.

These computer objects are stored in the RAM 211.

During a step E60, the processor 210 processes the object O₂, which consists in executing the code contained in that object, i.e. read the price P_{A} of the article A of the invoice in a database.

The compilation step E70 performed by the processor 210 consists in combining the partial results obtained during the first and second iterations, which results are stored in the RAM 211, in order to verify whether they make it possible to obtain a “final” result in the meaning of the invention, namely a result satisfying the initial objective of calculating the amount M of the invoice F.

Specifically, this applies since the only unknown P_{A} in the formula of the code of the object O₁ has been returned by interpreting the code of the object O₂.

Consequently, the step E70 is followed by the step E80, during which the sender means 250 respond to the initial objective by sending the final response as constituted by the amount M(P_{A}) obtained by multiplying the quantity Q from the invoice F by the price P_{A} returned by executing the code of the object O₂.

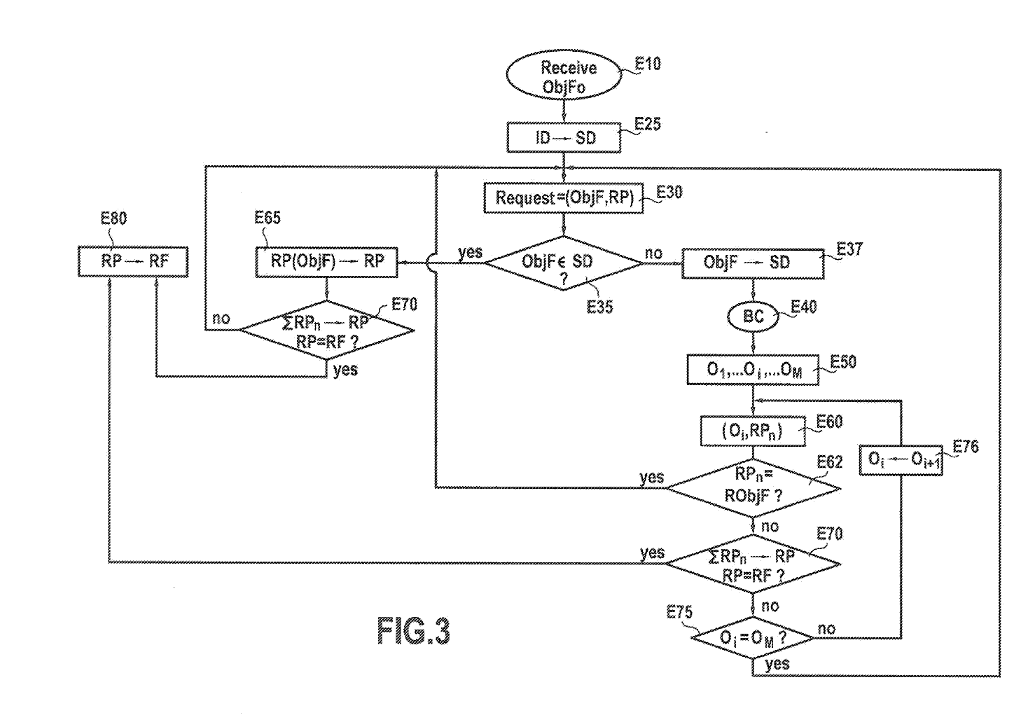

FIG. 3 shows the method of the invention in a second implementation. This method may be implemented by a generic engine (not shown) of hardware architecture that differs from that of FIG. 2 in that it also includes a static data structure SD. In this implementation, the computer program stored in the ROM 212 includes instructions for implementing the flow chart of FIG. 3.

It differs from the flow chart described with reference to FIG. 1 in that it makes it possible to use the static data structure SD to store the current objective ObjF defined during the various iterations together with the partial results, thus making it possible to reuse those partial results so long as they are available. This avoids systematically reinterpreting the modules of the objects Oᵢ of the knowledge base 300, for example if the user sends two similar initial objectives close together in time. It is also possible to store the other results, namely the compiled partial results and the final results.

For this purpose, in this second implementation, the method includes a step E25 of creating an identifier specific to the initial objective and of storing the identifier in the data structure, with the current objectives of the partial results RPₙ as defined and obtained during future iterations being stored in association with this identifier.

In the presently-described implementation, when a partial result RPₙ is stored in the data structure, it is stored in association with a duration for which the results are valid. With reference to FIG. 1, it should be recalled that in the first implementation, the knowledge base 300 is always interrogated (step E40) after a request has been defined (step E30) .

In this second implementation, when a current objective ObjF (or indeed the initial objective in the first iteration) is defined in step E30, the static data structure is interrogated in order to verify whether a result RPₙ of lifetime that has not yet expired is associated in the static data structure with this current objective.

Two things need to be verified, namely: that the time stamp has not expired and that the result does indeed satisfy.

If a valid and non-expired result RPₙ is indeed associated in the database with the current objective, then there is no need to interrogate (E40) the knowledge base 300, and the stored result RPₙ can be re-used directly during a step E65.

In contrast, if the data structure does not include a valid and non-expired result RPₙ in association with the current objective as defined in step E30, then the generic engine acts in step E37 to store the current objective in the static data structure SD and then to send the request to the knowledge base 300. All of the following steps are the same as the first implementation described with reference to FIG. 1.

It should be observed that as in the first implementation, the various results and objectives are stored in the RAM 211.

What is claimed is:

1. A method performed by a generic engine for dynamically creating a software application suitable for satisfying an initial objective received by said engine, said engine being suitable for interrogating a knowledge base including at least one computer object, each object including at least one module interpretable by said engine together with a description of a result obtained by said engine on interpreting said module;
said method comprising at least one iteration, each iteration comprising:
sending a request to said knowledge base, the request being constructed from a “current” objective, in order to obtain at least one computer object such that interpreting a module of said object by the engine aims to obtain at least a “partial” result suitable for satisfying said current objective, at least in part;
obtaining at least one result by interpreting at least one module of a computer object received during the iteration;
obtaining a compiled partial result by compiling at least one of said partial results obtained during said iterations in order to determine whether they enable a “final” result to be formed that satisfies the initial objective;
if so, sending the final result in response to the initial objective; and
if not, defining at least one new current objective defined from at least one of said results or from said complied partial result and possibly current objectives defined during preceding iterations, and executing the following iteration; and
the current objective included in the request sent during the first said iteration being constituted by the initial objective, said software application corresponding to the operations performed by said engine in order to satisfy said initial objective.

2. A method according to claim 1, Including:
a step of creating an identifier specific to the initial objective on receiving said initial objective;
a step of storing the identifier in a static data structure, said current objectives and their partial results being stored in association with the identifier
a step of interrogating said static data structure to determine whether the current objective is stored in the static data structure in association with a valid partial result; and if so:
replacing said steps of sending the request to the knowledge base, of receiving a list of objects selected by the knowledge base, and of obtaining at least one result, by a step of reading said static data structure to obtain the partial result.

3. A method according to claim 2, wherein said partial result, is valid if it is stored in the static data structure with a non-expired lifetime.

4. A method according to claim 1, wherein said objects received in response to a said request include an order number, said at least one module that is interpreted during said iteration step being determined as a function of the order number of the object to which it relates.

5. A method according to claim 1, wherein interpreting the module causes a command to be sent to a third-party component, the response to said command being used to obtain said result.

6. A computer program including instructions for executing the method of creating a software application according to claim 1, when said program is executed by a computer.

7. A computer readable storage medium having stored thereon a computer program containing instructions for executing steps of the method of a software application according to claim 1.

8. A generic engine suitable for dynamically creating a software application suitable for satisfying an initial objective received by said engine, said engine being suitable, for communicating with a knowledge base including at least one computer object, each computer object including at least one module interpretable by said engine together with a description of a result obtained by said engine on interpreting said module, said engine including control means suitable for acting during at least one iteration to make use of:
means for sending a request to said knowledge base, the request being constructed from a “current” objective, in order to obtain at least one computer object such that interpreting a module of said object by the engine aims to obtain at least one “partial” result suitable for satisfying said current objective, at least in part;
means for obtaining at least one result by interpreting at least one module of a computer object received from the knowledge base during said iteration;
means for obtaining a compiled partial result by compiling at least one of said results obtained during said iterations in order to determine whether they enable a “final” result to be formed that satisfies the initial objective; and
means for sending the final result in response to the initial objective, which means are triggered by said control means when said compiled partial result constitutes a final result and satisfies the initial objective;
said control means being configured, when said compiled partial result does not constitute said final result to:
trigger means for defining at least one new current objective defined from at least one of said results or from said compiled partial result and possibly from current objectives defined during preceding iterations; and
executing a new iteration;
the current objective included in the request sent during the first iteration being constituted by the initial objective, said software application corresponding to the operations performed by said engine in order to satisfy said initial objective.

9. A system for creating a software application, said system comprising:
a generic engine according to claim 8; and
a knowledge base.

10. A system according to claim 9, wherein the knowledge base includes an information hierarchy, and wherein said knowledge base returns to the engine only objects having a description that contains information of position in the hierarchy that is compatible with the request.

11. A system according to claim 9, wherein the initial objective is accompanied by data for authenticating the user originating the initial objective, or by data for authenticating an application originating the initial objective, and wherein said knowledge base returns to the engine objects that are selected as a function of the authentication data.
